(19) United States
(12) Patent Application Publication
(10) Pub. No.: US 2015/0378282 A1
(43) Pub. Date: Dec. 31, 2015

(54) TRANSFER MEMBER AND IMAGE FORMING APPARATUS

(71) Applicant: Konica Minolta, Inc., Tokyo (JP)

(72) Inventors: Akihiro HONYA, Tokyo (JP); Hidehito HARUKI, Tokyo (JP)

(21) Appl. No.: 14/753,833

(22) Filed: Jun. 29, 2015

(30) Foreign Application Priority Data
Jun. 30, 2014 (JP) 2014-133925

(51) Int. Cl. C08K 3/22; G03G 15/01; C08F 230/08

(52) U.S. Cl. CPC G03G 15/162

(57) ABSTRACT

Provided is a transfer member having high durability, and an image forming apparatus which enables stable forming of an image with high image quality for a long period of time.

The transfer member is an endless belt shape transfer member for constituting an image forming apparatus of an electrophotographic type, in which a surface layer is formed on a base and the surface layer comprises a cured (meth)acrylic resin which is obtained by curing of polyfunctional (meth)acrylate according to a polymerization reaction using a photopolymerization initiator comprising of an acylphosphine oxide compound represented by the following General Formula (1):

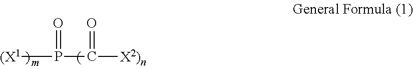

[in General Formula (1), n and m each represents an integer of 1 to 2 (with the proviso that, the relationship of m+n=3 is satisfied), and X¹ and X² each represents an alkyl group, a phenyl group which may have a substituent group, or an alkoxy group].

### BACKGROUND

1. Technical Field

The present invention relates to a transfer member and an image forming apparatus having the transfer member.

2. Description of Related Art

With regard to an image forming apparatus of an electrophotographic type, a latent image formed on an image carrier (photosensitive body) is developed by a toner, the obtained toner image is temporarily maintained by a transfer member with an endless belt shape (hereinbelow, also referred to as an “intermediate transfer belt”), and the toner image on the intermediate transfer belt is transferred onto a recording medium like paper, for example.

As for the intermediate transfer belt, a base including a polyimide resin or the like on which a surface layer including a hard resin is formed as a measure for improving abrasion resistance or scratch resistance is known. (see, Patent Documents; Japanese Patent Application Laid-Open No. 2007-316622 (JP-A), JP-A2000-310912, JP-A2004-334029, JP-A 2003-131492, JP-A 2007-25288, JP-A H11-267583, and JP-A H10-207242).

However, as the resin for forming a surface layer is deteriorated by discharge during an image forming process or a discharge product resulting from such discharge, abrasion resistance or scratch resistance is lowered over time, and thus desired durability is not obtained. Furthermore, the surface resistance of the intermediate transfer belt is lowered due to deterioration of a resin which constitutes a surface layer, and as a result, scattering of toner particles occurs on a toner image to be transferred on the intermediate transfer belt, and therefore there is a problem that fine line reproducibility is lowered in an image to be formed.

### SUMMARY

The present invention is devised under the circumstances described above, and an object of the invention is to provide a transfer member having high durability.

Another object of the present invention is to provide an image forming apparatus which allows stable forming of an image with high image quality for a long period of time.

In order to achieve at least one of the objects, a transfer member in which one aspect of the present invention is reflected is a transfer member with an endless belt shape for constituting an image forming apparatus of an electrophotographic type, wherein a surface layer is formed on a base, and the surface layer includes a cured (meth)acrylic resin which is obtained by curing of polyfunctional (meth)acrylate according to a polymerization reaction using a photopolymerization initiator including an acylphosphine oxide compound represented by the following General Formula (1).

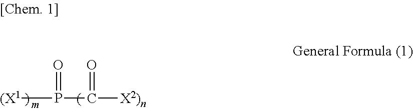

[in General Formula (1), n and m each represents an integer of 1 to 2 (with the proviso that, the relationship of m+n=3 is satisfied), and X¹ and X² each represents an alkyl group, a phenyl group which may have a substituent group, or an alkoxy group].

Another object, characteristics, special features of the present invention will be known in view of the preferred embodiments that are exemplified in the following descriptions.

### BRIEF DESCRIPTION OF THE DRAWINGS

FIG. 1(a) is an explanatory cross-sectional view illustrating one example of a constitution of a transfer member of a first embodiment, and FIG. 1(b) is an explanatory cross-sectional view illustrating another example of a constitution of a transfer member of the first embodiment;

FIG. 2 is an explanatory cross-sectional view illustrating one example of a constitution of a coating device that is used for forming a surface layer constituting a transfer member of the first embodiment; and

FIG. 3 is an explanatory cross-sectional view illustrating one example of a constitution of an image forming apparatus of a second embodiment.

### DETAILED DESCRIPTION

Hereinbelow, modes for carrying out the present invention are described in detail.

[Transfer Member]

The transfer member as the first embodiment of the present invention has an endless belt shape for constituting an image forming apparatus of an electrophotographic type, and it is characterized in that a surface layer is formed on a base and the surface layer includes a cured (meth)acrylic resin, which is obtained by curing of polyfunctional (meth)acrylate according to a polymerization reaction using a photopolymerization initiator including an acylphosphine oxide compound represented by the above General Formula (1) (hereinbelow, it is also referred to as a “specific photopolymerization initiator”).

According to the transfer member as the first embodiment of the present invention, the surface layer includes a cured (meth)acrylic resin which is obtained by curing according to a polymerization reaction using a specific photopolymerization initiator, and thus high durability is obtained.

Furthermore, a preferred embodiment of the transfer member is as follows; the surface layer contains the cured (meth)acrylic resin and surface-treated metal oxide microparticles, and the cured (meth)acrylic resin is obtained by curing of the polyfunctional (meth)acrylate and a polymerizable compound having a low surface energy group other than the polyfunctional (meth)acrylate according to a polymerization reaction which uses the photopolymerization initiator including the acylphosphine oxide compound represented by the above General Formula (1).

Furthermore, for achieving at least one of the objects described above, the image forming apparatus of an electrophotographic type reflecting one feature of the present invention is an image forming apparatus which includes a first transfer means for first transfer of a toner image that is formed electrostatically on an image carrier to a circularly moving intermediate transfer belt and a second transfer means for second transfer of an intermediate toner image that is formed on the intermediate transfer belt to an image support, in which the intermediate transfer belt is made of the aforementioned transfer member.

According to the image forming apparatus as the second embodiment of the present invention, the intermediate transfer belt is made of the aforementioned transfer member, and thus an image with high image quality can be stably formed for a long period of time.

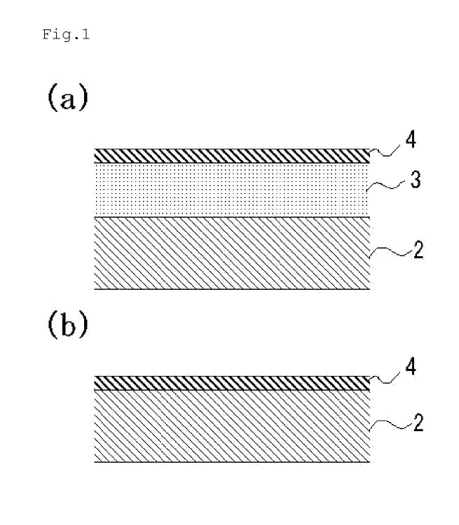

Specifically, according to a transfer member of the first embodiment, a surface layer is formed on a base. As illustrated in FIG. 1(b), a surface layer 4 may be directly formed on a base 2. Alternatively, as illustrated in FIG. 1(a), the surface layer 4 may be formed on the base 2 intermediated by an elastic body layer 3.

[Base 2]

The base 2 for constituting a transfer member of the first embodiment has an endless belt shape, and it may have a monolayer constitution or plural layer constitution with two or more layers.

The material for constituting the base 2 is not particularly limited, and for example, those including a polyimide resin, a polymethyl methacrylate resin, a polycarbonate resin, a polystyrene resin, an acrylonitrile•styrene copolymer resin, a polyvinyl chloride resin, an acetate resin, an ABS resin, a polyester resin, or a polyamide resin can be used. Those including a polyimide resin are preferably used. Furthermore, the base 2 preferably has conductivity according to dispersion of a conducting agent in a resin like those described above.

Considering the mechanical strength, image quality, production cost, or the like, the thickness of the base 2 is preferably 50 to 250 μm.

[Elastic Body Layer 3]

The elastic body layer 3 is formed depending on the necessity. The elastic body layer 3 includes an elastic body, and examples of a constitutional material include rubber, an elastomer, and a resin. From the viewpoint of durability, it is particularly preferable to contain chloroprene rubber.

The layer thickness of the elastic body layer 3 is preferably 200 to 500 μm considering mechanical strength, image quality, production cost, or the like.

[Surface Layer 4]

The surface layer 4 constituting a transfer member of the first embodiment includes a cured (meth)acrylic resin, and it preferably includes a cured (meth)acrylic resin which contains surface-treated metal oxide microparticles.

The cured (meth)acrylic resin is obtained by curing of polyfunctional (meth)acrylate according to a polymerization reaction. It is preferably obtained by curing of polyfunctional (meth)acrylate and a polymerizable compound having a low surface energy group other than the polyfunctional (meth)acrylate according to a polymerization reaction.

The cured (meth)acrylic resin may be also obtained by curing of polyfunctional (meth)acrylate, a polymerizable compound having a low surface energy group other than the polyfunctional (meth)acrylate, and a polymerizable component including polyurethane acrylate according to a polymerization reaction. For a case in which the elastic body layer 3 is formed, polyurethane acrylate has a function of enabling the surface layer 4 to follow the elastic body layer 3. As such, when the elastic body layer 3 is formed, it is preferable to use polyurethane acrylate.

[Specific Photopolymerization Initiator]

The specific photopolymerization initiator for forming the cured (meth)acrylic resin constituting the surface layer 4 of a transfer member of the first embodiment is an acylphosphine oxide compound, and it is represented by the above General Formula (1). According to a transfer member of the first embodiment, the surface layer includes a cured (meth)acrylic resin which is obtained by curing according to a polymerization reaction which uses the specific photopolymerization initiator, and thus high durability is obtained.

In General Formula (1), X¹ and X² each represents an alkyl group, a phenyl group which may have a substituent group, or an alkoxy group.

The alkyl group is preferably a linear or branched alkyl group having 1 to 6 carbon atoms, and more preferably a linear or branched alkyl group having 1 to 4 carbon atoms. Specific examples of the alkyl group include a methyl group, an ethyl group, a propyl group, an isopropyl group, a butyl group, a tert-butyl group, a pentyl group, and a hexyl group.

The alkoxy group is preferably a linear or branched alkoxy group having 1 to 6 carbon atoms, and more preferably a linear or branched alkoxy group having 1 to 4 carbon atoms. Specific examples of the alkoxy group include a methoxy group, an ethoxy group, a propoxy group, an isopropoxy group, a butoxy group, a tert-butoxy group, a pentyloxy group, and a hexyloxy group.

The substituent group on the phenyl group is preferably an alkyl group having 1 to 3 carbon atoms or an alkoxy group having 1 to 3 carbon atoms. Examples of the alkyl group having 1 to 3 carbon atoms or alkoxy group having 1 to 3 carbon atoms include a methyl group, an ethyl group, a methoxy group, and an ethoxy group. In addition, when the phenyl group has a substituent group, it is preferable that the hydrogen at any one of position 2, position 4, and position 6 be substituted with a substituent group. For example, a phenyl group in which (1) position 2, (2) position 4, (3) position 2 and position 4, (4) position 2, position 4, and position 6 is/are substituted with a methyl group and/or a methoxy group is preferable.

Furthermore, in General Formula (1), n and m each represents an integer of 1 to 2 (with the proviso that, the relationship of m+n=3 is satisfied).

Specific examples of the specific photopolymerization initiator include a compound represented by Formula (1-1) to Formula (1-11) shown below.

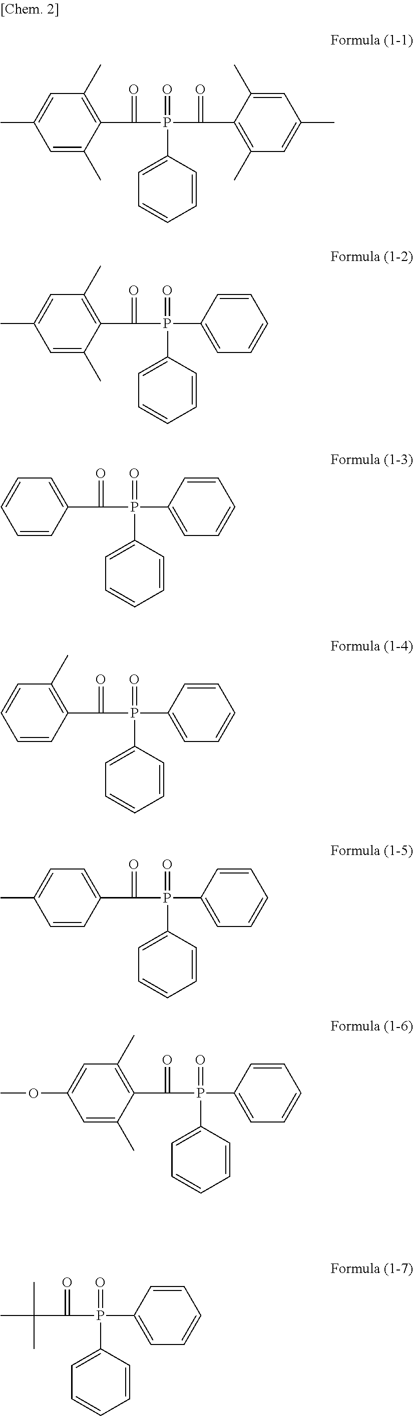

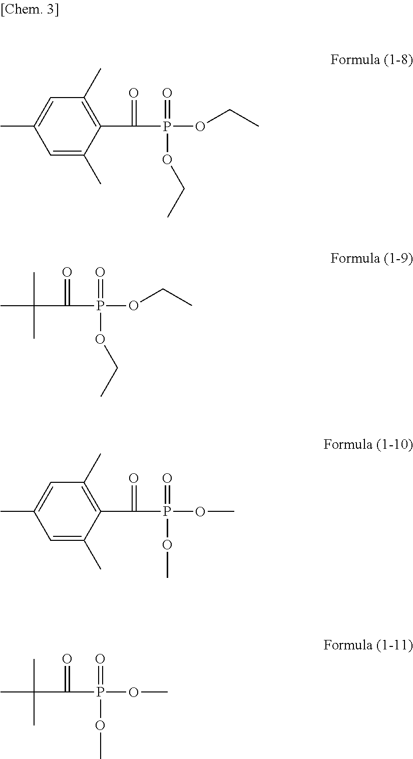

As for the specific photopolymerization initiator, a compound represented by Formula (1-1) to Formula (1-7) shown above is preferably used.

Content ratio of the specific photopolymerization initiator is, relative to 100 parts by weight of a polymerizable component, preferably 1 to 10 parts by weight, more preferably 2 to 8 parts by weight, and even more preferably 3 to 6 parts by weight.

[Polyfunctional (Meth)Acrylate]

The polyfunctional (meth)acrylate has two or more (meth)acryloyloxy groups in one molecule, and it is used for exhibiting abrasion resistance, toughness, and adhesiveness of the surface layer 4 of a transfer member. Specific examples thereof include a bifunctional monomer such as bis(2-acryloxyethyl)-hydroxyethyl-isocyanurate, 1,6-hexanediol diacrylate, 1,4-butanediol diacrylate, 1,9-nonanediol diacrylate, neopentyl glycol diacrylate, hydroxypyvalic acid neopentyl glycol diacrylate, or urethane acrylate; and a polyfunctional monomer having functionality of 3 or more such as trimethylol propane triacrylate (TMPTA), pentaerythritol triacrylate, tris(acryloxyethyl)isocyanurate, ditrimethylol propane tetraacrylate, pentaerythritol tetraacrylate (PETTA), dipentaerythritol hexaacrylate (DPHA), urethane acrylate, or an ester compound synthesized from polyfunctional alcohol, polybasic acid, and (meth)acrylic acid, for example, an ester compound synthesized from trimethylol ethane/succinic acid/acrylic acid=2/1/4 mole. To give a hard coating property to a coating film, it is preferable to use polyfunctional acrylate having functionality of 3 or more.

The polyfunctional (meth)acrylate preferably has number average molecular weight of 3,000 or less, and more preferably 200 or more and 1,000 or less.

As the number average molecular weight of the polyfunctional (meth)acrylate is within the aforementioned range, density of a cured (meth)acrylic resin can be improved so that high strength is obtained.

In the present invention, the average molecular weight of the polyfunctional (meth)acrylate is a value measured by gel permeation chromatography which uses the polyfunctional (meth)acrylate as a measurement sample. Specific measurement conditions are mentioned below. The measurement sample was dissolved in tetrahydrofuran at 40° C., and the sample dissolved was confirmed by visual judgment.

GPC device: HLC-8220GPC (manufactured by Tosoh Corporation)

Column: TSKgelG2000HXL (Inner diameter 7.8 mm×30 cm) 3 series (manufactured by Tosoh Corporation)

Temperature of column: 40° C.

Solvent: Tetrahydrofuran

Flow rate: 1.0 mL/min

Concentration of the sample: 0.1% (v/w)

Injection amount of the sample: 100 μL

Detector: Refraction index detector (RI detector)

Calibration curve: Standard polystyrene, n-hexylbenzene

The detective level of the above column is calculated by polystyrene conversion as 10,000.

Meanwhile, as described herein, the number average molecular weight of those other than the polyfunctional (meth)acrylate is also measured by the aforementioned method.

It is preferable that the polyfunctional (meth)acrylate be contained at ratio of 20 to 90% by weight in the polymerizable component.

[Polymerizable Compound Having Low Surface Energy Group]

With regard to the polymerizable compound having a low surface energy group, the low surface energy group indicates a functional group which has a function of lowering surface free energy of a surface layer. Specifically, it indicates an acrylate group which is modified with silicone or fluorine. Examples of a silicone modified part include dimethyl polysiloxane and methyl hydrogen polysiloxane. Examples of a fluorine modified part include polytetrafluoroethylene (PTFE), tetrafluoroethylene•perfluoroalkyl vinyl ether copolymer (PFA).

Specific examples of the polymerizable compound having a low surface energy group include a vinyl copolymer having number average molecular weight of 5,000 or more and 100,000 or less in which one or more polyorganosiloxane chain or polyfluoroalkyl chain and three or more radical polymerizable double bounds are contained (hereinbelow, it is also referred to as a “specific vinyl copolymer”).

The specific vinyl copolymer is obtained by reacting the vinyl polymer (A), which is obtained by radical polymerization of the monomer (a) which has a radical polymerizable double bond and a polyorganosiloxane group or a polyfluoroalkyl group, the monomer (b) which has a radical polymerizable double bond and a reactive functional group and is different from the monomer (a), and if necessary, the monomer (c) which has a radical polymerizable double bond which is different from the monomer (a) and the monomer (b), and the compound (B) having a radical polymerizable double bond and a functional group which can react with the aforementioned reactive functional group.

The specific vinyl copolymer can be also obtained by polymerizing the monomer (a), a monomer (c′) having two or more radical polymerizable double bonds, and if necessary, the monomer (c). When the monomer (c′) is present in a small amount, a desired vinyl copolymer can be obtained without gellation. It is also possible that part or all of the monomer (c′) is prepared not to easily undergo the gellation by protecting part of the radical polymerizable double bond with addition of a blocking group.

When the number average molecular weight of the specific vinyl copolymer is less than 5,000, an easily-crystallizing constitution is yielded so that the productivity is significantly lowered, and thus undesirable. On the other hand, when the number average molecular weight of the vinyl copolymer is more than 100,000, surface hardness is lowered when it is prepared as a surface layer, and the function as a transfer member is lowered, and thus it is undesirable.

In the present invention, the number average molecular weight of the specific vinyl copolymer is a value which is measured by gel permeation chromatography (manufactured by Shimadzu Corporation).

The monomer (a) is to lower the surface free energy of a surface layer.

Examples of the monomer (a) having a radical polymerizable double bond and a polyorganosiloxane group include a compound that is represented by the following General Formula (2).

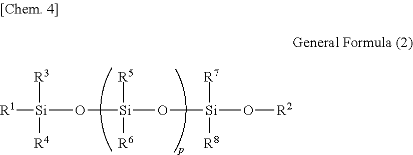

[in General Formula (2), R¹ represents CH₂═CHCH₂—COO—(CH₂)_{q}—, CH₂═C(CH₃)—COO—(CH₂)_{q}—, CH₂═CH—(CH₂)_{q}—, or CH₂═C(CH₃)—(CH₂)_{q}—, (q is an integer of 0 to 10), R² represents a hydrogen atom, a methyl group, or the same functional group as R¹, R³, R⁴, R⁵, R⁶, R⁷ and R⁸ represent an alkyl group or a phenyl group, and p represents a positive integer].

Meanwhile, the hydrogen atom in the group represented by R¹ to R⁸ may be substituted with a known substituent group other than a hydrogen atom within a range in which the effect of the present invention is not lost.

Examples of the monomer (a) having a radical polymerizable double bond and a polyorganosiloxane group include a polyorganosiloxane compound having vinyl group at single terminal such as TSL9705 manufactured by Toshiba Silicone and a polyorganosiloxane compound having (meth)acryloxy group at single terminal such as Silaplane FM-0711, FM-0721, or FM-0725 manufactured by JNC.

Examples of the monomer (a) having a radical polymerizable double bond and a polyfluoroalkyl group include perfluoroalkylethylacrylate.

The monomer (a) may be used either singly or as a mixture of two or more types depending on required performance.

Copolymerization ratio of the monomer (a) in the vinyl polymer (A) is, considering surface free energy on a surface of a surface layer of a transfer member, compatibility with other components that are contained in a coating liquid for forming a surface layer which is described below, adhesiveness to the elastic body layer 3 for a case of forming the elastic body layer 3, and coating performance like toughness and solubility of the polymer in a solvent, preferably 1 to 80% by weight, more preferably 5 to 50% by weight, and particularly preferably 10 to 45% by weight on the basis of the total weight of the monomers constituting the polymer.

The monomer (b) having a radical polymerizable double bond and a reactive functional group which is different from the monomer (a) serves as a start point for introducing a radical polymerizable double bond to the vinyl polymer (A) for first polymerization, and it is provided to suppress bleeding of a vinyl polymer and to form a strong wall according to setting by cross-linking of introduced radical polymerizable double bond by active energy ray.

Examples of the reactive functional group include a hydroxy group, a carboxy group, an isocyanate group, and an epoxy group.

Specific examples of the monomer (b) having a hydroxyl group include 2-hydroxyethyl(meth)acrylate, 1-hydroxypropyl(meth)acrylate, 2-hydroxypropyl(meth)acrylate, 4-hydroxybutyl(meth)acrylate, polyethylene glycol mono(meth)acrylate, polypropylene glycol mono(meth)acrylate, polytetramethylene glycol mono(meth)acrylate, and hydroxystyrene.

Specific examples of the monomer (b) having a carboxy group include acrylic acid, methacrylic acid, crotonic acid, maleic acid, fumaric acid, itaconic acid, and citraconic acid.

Specific examples of the monomer (b) having an isocyanate group include (meth)acryloyloxyethylisocyanate, (meth)acryloyloxypropylisocyanate, and a product obtained by reacting hydroxyalkyl(meth)acrylate like 2-hydroxyethyl(meth)acrylate and 4-hydroxybutyl(meth)acrylate with polycyanate like toluene diisocyanate and isophorone diisocyanate.

Specific examples of the monomer (b) having an epoxy group include glycidyl methacrylate, glycidyl cinnamate, glycidyl allyl ether, glycidyl vinyl ether, vinyl cyclohexane monoepoxide, and 1,3-butadiene monoepoxide. The monomer (b) may be used either singly or as a mixture of two or more types depending on required performance.

Copolymerization ratio of the monomer (b) in the vinyl polymer (A) is, considering abrasion resistance, hardness, surface free energy or the like of a surface layer of a transfer member, preferably 10 to 90% by weight, more preferably 30 to 90% by weight, and particularly preferably 40 to 85% by weight on the basis of the total weight of the monomers constituting the polymer.

The monomer (c) having a radical polymerizable double bond which is different from the monomer (a) and the monomer (b) issued for enhancing compatibility between a vinyl polymer and other components that are included in a coating liquid for forming a surface layer as described below, and for providing physical properties like hardness, toughness, and abrasion resistance, or the like of a surface layer of a transfer member.

Examples of the monomer (c) include (I) the (meth)acrylic acid derivative, (II) the aromatic vinyl monomer, (III) the olefin-based hydrocarbon monomer, (IV) the vinyl ester monomer, (V) the vinyl halide monomer, and (VI) the vinyl ether monomer.

Specific examples of (I) the (meth) the acrylic acid derivative include (meth)acrylonitrile, and alkyl(meth)acylate such as methyl (meth)acrylate, butyl (meth)acrylate, ethylhexyl(meth)acrylate, stearyl(meth)acrylate, and benzyl (meth)acrylate.

Specific examples of (II) the aromatic vinyl monomer include styrenes such as styrene, methyl styrene, ethyl styrene, chlorostyrene, monofluoromethyl styrene, difluoromethyl styrene, and trifluoromethyl styrene.

Specific examples of (III) the olefin-based hydrocarbon monomer include ethylene, propylene, butadiene, isobutylene, isoprene, and 1,4-pentadiene.

Specific examples of (IV) the vinyl ester monomer include vinyl acetate.

Specific examples of (V) the vinyl halide monomer include vinyl chloride and vinylidene chloride.

Specific examples of (VI) the vinyl ether monomer include vinyl methyl ether. These monomers can be used as a mixture of two or more types.

Copolymerization ratio of the monomer (c) in the vinyl polymer (A) is, considering enhancement of compatibility between the vinyl polymer (A) and other components that are included in a coating liquid for forming a surface layer which is described below, preferably 0 to 89% by weight on the basis of the total weight of the monomers constituting the polymer.

The vinyl polymer (A) can be synthesized by a known method, for example, a solution polymerization. Examples of the solvent which can be used for the polymerization include ketones such as acetone, methyl ethyl ketone, methyl isobutyl ketone, and cyclohexanone, ethers such as tetrahydrofuran, dioxane, ethylene glycol dimethyl ether, or diethylene glycol dimethyl ether, aromatic compounds such as benzene, toluene, xylene, or cumene, and esters such as ethyl acetate or butyl acetate. The solvent can be used as a mixture of two or more types. The injection concentration of the monomer is preferably 0 to 80% by weight at the time of the polymerization.

As a polymerization initiator, a typical peroxide or an azo compound, for example, benzoyl peroxide, azoisobutyl valeronitrile, azobisisobutyronitrile, di-t-butyl peroxide, t-butyl perbenzoate, t-butyl peroctoate, and cumene hydroxy peroxide, are used. The polymerization temperature is preferably 50 to 140° C., and more preferably 70 to 140° C.

Preferred number average molecular weight of the vinyl polymer (A) to be obtained is 5,000 to 100,000.

When the vinyl polymer (A) having a reactive functional group and a polyorganosiloxane chain or a polyfluoroalkyl chain that is obtained as described above is reacted with the compound (B) having a functional group which can react with the reactive functional group and a radical polymerizable double bond, a vinyl copolymer having a radical polymerizable double bond and a polyorganosiloxane chain or a polyfluoroalkyl chain is obtained.

Reaction of the vinyl polymer (A) with the compound (B) is preferably performed at ratio enabling that the number of a functional group which can react with the reactive functional group is 100% relative to the number of the reactive functional group contained in the vinyl polymer (A). As long as the photoreactivity is not impaired, the reaction may be allowed to occur at the ratio of less than 100%.

As for the combination of the reactive functional group and the functional group which can react with the reactive functional group, various known combinations and reaction methods that are described below can be employed.

1) For a case in which the reactive functional group is a hydroxyl group, representative examples of the functional group which can react with the reactive functional group include an acid halide group and an isocyanate group. Specifically, according to a reaction with (meth)acrylic acid chloride or (meth)acryloxyethyl isocyanate, a radical polymerizable double bond can be introduced. Reaction with (meth)acrylic acid chloride progresses by adding a catalyst to a solution of a polymer having a polyorganosiloxane chain or a polyfluoroalkyl chain and a hydroxyl group and then adding (meth)acrylic acid chloride followed by heating. Examples of the solvent which can be used include ketones such as 2-butanone, methyl isobutyl ketone, or cyclohexanone, esters such as ethyl acetate, propyl acetate, or butyl acetate, and an ether solution such as ethylene glycol dimethyl ether or dioxolane. As a catalyst, triethylamine, dimethyl benzylamine or the like are preferable. The catalyst amount is 0.1% by weight to 1% by weight relative to a solid content. The reaction is performed under air to suppress gellation, the reaction temperature is 80° C. to 120° C., and the reaction time is 1 hour to 24 hours.

Reaction with (meth)acryloxyethyl isocyanate progresses according to addition of a metal compound such as tin octylate, tin dibutyl dilaurate, or zinc octylate as a catalyst, or a tertiary amine such as triethyle amine, tributyl amine, or dimethyl benzyl amine as a catalyst at 0.05 PHR to 1 PHR (Per Hundred Resin) toa solution of a polymer having a polyorganosiloxane chain or a polyfluoroalkyl chain and a hydroxyl group, and adding methacryloxyethyl methacrylate under heating. Examples of the solvent which can be used include ketones such as 2-butanone, methyl isobutyl ketone, or cyclohexanone, esters such as ethyl acetate, propyl acetate, or butyl acetate, and an ether solution such as ethylene glycol dimethyl ether or dioxolane.

2) For a case in which the reactive functional group is an epoxy group, representative examples of the functional group which can react with the reactive functional group include a carboxy group. Specifically, according to a reaction with (meth)acrylic acid, a radical polymerizable double bond can be introduced. Reaction with (meth)acrylic acid progresses by adding a catalyst to a solution of a polymer having a polyorganosiloxane chain or a polyfluoroalkyl chain and an epoxy group and adding (meth)acrylic acid followed by heating. Preferred reaction conditions are the same as those conditions for above i) in which the reactive functional group is a hydroxyl group, but tertiary amine is most preferable as a catalyst. Examples of a compound having a carboxy group and a radical polymerizable double bond include, in addition to (meth)acryl acid, succinate anhydride adduct of pentaerythritol triacrylate and (meth)acryloxyethyl phthalate.

3) For a case in which the reactive functional group is an isocyanate group, representative examples of the functional group which can react with the reactive functional group include a hydroxy group. Specific examples thereof include hydroxyethyl(meth)acrylate, hydroxypropyl(meth)acrylate, hydroxybutyl(meth)acrylate, and ε-caprolactone adduct of hydroxyethyl(meth)acrylate. Preferred reaction conditions are the same as those conditions for above 1) in which the reactive functional group is a hydroxyl group.

The content of the monomer (a) having a polyorganosiloxane chain or a polyfluoroalkyl chain can be, on the basis of the total weight of non-volatiles in a coating liquid for forming a surface layer, 0.01 to 10% by weight. Because a vinyl copolymer which has one polyorganosiloxane chain or polyfluoroalkyl chain and at least three radical polymerizable double bonds and number average molecular weight of 5,000 to 100,000 has a property of being concentrated on a surface when a coating liquid for forming a surface layer is coated, sufficiently low surface free energy can be exhibited even when the amount of the monomer (a) is small.

With regard to the vinyl copolymer which has at least one polyorganosiloxane chain or polyfluoroalkyl chain and at least three radical polymerizable double bonds and number average molecular weight of 5,000 or more and 100,000 or less as a polymerizable compound having a low surface energy group, a commercially available “MEGAFUCK” (manufactured by DIC) and “FULL SHADE” manufactured by TOYO INK Co., LTD.) can be used.

The polymerizable compound having a low surface energy group is preferably contained at ratio of 1 to 30% by weight in the polymerizable component.

[Polyurethane Acrylate]

Polyurethane acrylate is used, if required. Polyurethane acrylate is a polymer which has a urethane bond and one or more acryloxyloxy groups in one molecule.

Examples of the polyurethane acrylate include a compound in which a urethane bond is contained in a main skeleton and one or more acryloyloxy groups are bonded at an end or a side chain of the main skeleton.

The number average molecular weight of the polyurethane acrylate is preferably 3,000 or more and 30,000 or less, and particularly preferably 10,000 or more and 20,000 or less.

As the number average molecular weight of the polyurethane acrylate is within this range, the cured (meth)acrylic resin can be provided with flexibility and an elongation property and also a decrease in strength can be suppressed.

The number average molecular weight of the polyurethane acrylate is measured in the same manner as the measurement of molecular weight of the polyfunctional (meth)acrylate except that the measurement sample is changed to polyurethane acrylate.

The polyurethane acrylate is preferably contained at ratio of 30 to 70% by weight in the polymerizable component.

In the cured (meth)acrylic resin which is obtained by curing based on polymerization of the polymerizable components described above, content ratio of a structural unit derived from the polyfunctional (meth)acrylate is preferably 20 to 90% by weight.

Furthermore, when it is formed by using a polymerizable compound having a low surface energy group, content ratio of a structural unit derived from the polymerizable compound having a low surface energy group is preferably 1 to 30% by weight in the obtained cured (meth)acrylic resin.

Furthermore, when it is formed by also using polyurethane acrylate, content ratio of a structural unit derived from the polyurethane acrylate is preferably 20 to 50% by weight in the obtained cured (meth)acrylic resin.

[Metal Oxide Microparticles]

In the surface layer 4 constituting a transfer member of the first embodiment, surface-treated metal oxide microparticles are preferably contained. By containing metal oxide microparticles in the surface layer 4, toughness is given to the surface layer 4, and thus high durability is obtained.

The metal oxide microparticles can be obtained by a surface treatment of non-treated metal oxide microparticles (hereinbelow, referred to as “non-treated metal oxide microparticles”) with a surface treatment agent.

As for the non-treated metal oxide microparticles that are used in the present invention, oxide of a metal including transition metal can be used. Examples thereof include silica (silicon oxide), magnesium oxide, zinc oxide, lead oxide, aluminum oxide, tantalum oxide, indium oxide, bismuth oxide, yttrium oxide, cobalt oxide, copper oxide, manganese oxide, selenium oxide, iron oxide, zirconium oxide, germanium oxide, tin oxide, titanium oxide, niobium oxide, molybdenum oxide, and vanadium oxide. Of these, titanium oxide, alumina, zinc oxide, and tin oxide are preferable. Alumina and tin oxide are particularly preferable.

As for the non-treated metal oxide microparticles, those produced by a common production method such as a gas phase method, a chloride method, a sulfuric acid method, a plasma method, or an electrolytic method are used.

The number average primary particle diameter of the non-treated metal oxide microparticles is preferably in a range of 1 nm or more and 300 nm or less. Particularly preferably, it is in a range of 3 nm to 100 nm. When the particle diameter is excessively small, abrasion resistance is insufficient. On the other hand, when it is excessively large, recording light may be scattered or insufficient abrasion resistance may be yielded due to suppressed photopolymerization by particles.

As for the number average primary particle diameter of the non-treated metal oxide microparticles, the number average primary particle diameter which is obtained by taking a 10,000× enlarged photographic image using a scanning electron microscope (manufactured by JEOL Ltd.) and calculating a number average primary particle diameter of particle in a photographic image (excluding aggregated particles), as has been obtained by scanning randomly photographic images of 300 particles, with use of an automatic image analyzer LUZEXAP (Nireco Corporation) software version Ver.1.32 is used.

Examples of the surface treatment agent which is used for a surface treatment of non-treated metal oxide microparticles include a compound having a radical polymerizable functional group. Examples of the radical polymerizable functional group include an acryloyl group and a methacryloyl group.

Furthermore, to provide a low surface energy property, silicone oil or a compound having a polyfluoroalkyl group can be used as a surface treatment agent. Examples of the silicone oil which may be used include straight silicone oil (for example, methyl hydrogen polysiloxane (MHPS) or the like) and modified silicone oil (for example, silicon oil having a single end modified with carbinol and silicone oil having a single end modified with diol).

In the present invention, the metal oxide microparticles preferably have a surface which is introduced with at least one of a radical polymerizable functional group and a low surface energy functional group. Herein, the low surface energy functional group indicates a functional group which is introduced by a surface treatment agent used for providing a low surface energy property, and examples thereof include a silicone oil group or a polyfluoroalkyl group coupled with silane. When both of them are introduced, the ratio between the radical polymerizable functional group and low surface energy functional group is preferably 2:1 to 1:2.

As for the surface treatment agent having a radical polymerizable functional group which is used for a surface treatment of non-treated metal oxide microparticles, a compound having, in the same molecule, both a functional group with carbon•carbon double bond and a polar group like an alkoxy group which couples with a surface hydroxyl group of the surface of non-treated metal oxide microparticles is preferable.

As for the surface treatment agent having a radical polymerizable functional group, compounds with a functional group to yield a resin like polystyrene, polyacrylate, or the like according to polymerization (curing) by irradiation of light like ultraviolet ray are preferable. Among them, from the viewpoint of having curing with a small light amount or within a short time, a silane compound having a reactive acryloyl group or a methacryloyl group is particularly preferable.

Examples of the surface treatment agent having a radical polymerizable functional group include a compound that is represented by the following General Formula (3).

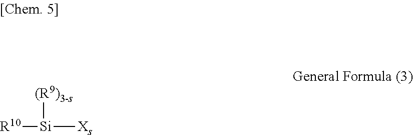

[in General Formula (3), R⁹ represents a hydrogen atom, an alkyl group having 1 to 10 carbon atoms, or an aralkyl group having 1 to 10 carbon atoms, R¹⁰ represents an organic group having a reactive double bond, X represents a halogen atom, an alkoxy group, an acyloxy group, an aminoxy group, or a phenoxy group, and s is an integer of from 1 to 3].

As a compound represented by the above General Formula (3), the following S-1 to S-30 can be mentioned.

S-1 CH₂═CHSi(CH₃)(OCH₃)₂

S-2 CH₂═CHSi(OCH₃)

S-3 CH₂═CHSiCl₃

S-4 CH₂═CHCOO(CH₂)₂Si(CH₃)(OCH₃)₂

S-5 CH₂═CHCOO(CH₂)₂Si(OCH₃)

S-6 CH₂═CHCOO(CH₂)₂Si(OC₂H₅)(OCH₃)₂

S-7 CH₂═CHCOO(CH₂)₃Si(OCH₃)

S-8 CH₂═CHCOO(CH₂)₂Si(CH₃)Cl₂

S-9 CH₂═CHCOO(CH₂)₂SiCl₃

S-10 CH₂═CHCOO(CH₂)₃Si(CH₃)Cl₂

S-11 CH₂═CHCOO(CH₂)SiCl₃

S-12 CH₂═C(CH₃)COO(CH₂)₂Si(CH₃)(OCH₃)₂

S-13 CH₂═C(CH₃)COO(CH₂)₂Si(OCH₃)

S-14 CH₂═C(CH₃)COO(CH₂)₃Si(CH₃)(OCH₃)₂

S-15 CH₂═C(CH₃)COO(CH₂)₃Si(OCH₃)₃

S-16 CH₂═C(CH₃)COO(CH₂)₂Si(CH₃)Cl₂

S-17 CH₂═C(CH₃)COO(CH₂)₂SiCl₃

S-18 CH₂═C(CH₃)COO(CH₂)₃Si(CH₃)Cl₂

S-19 CH₂═C(CH₃)COO(CH₂)₃SiCl₃

S-20 CH₂═CHSi(C₂H₅)(OCH₃)₂

S-21 CH₂═C(CH₃)Si(OCH₃)₃

S-22 CH₂═C(CH₃)Si(OC₂H₅)₃

S-23 CH₂═CHSi(OCH₃)₃

S-24 CH₂═C(CH₃)Si(CH₃)(OCH₃)₂

S-25 CH₂═CHSi(CH₃)Cl₂

S-26 CH₂═CHCOOSi(OCH₃)₃

S-27 CH₂═CHCOOSi(OC₂H₅)₃

S-28 CH₂═C(CH₃)COOSi(OCH₃)₃

S-29 CH₂═C(CH₃)COOSi(OC₂H₅)₃

S-30 CH₂═C(CH₃)COO(CH₂)₃Si(OC₂H₅)₃

Furthermore, other than the compound represented by the above General Formula (3), the following S-31 to S-33 can be used as a compound having a radical polymerizable functional group.

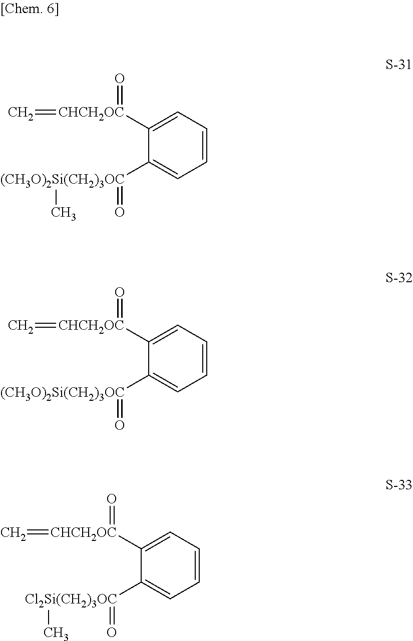

The above compound can be used either singly or in combination or two or more types.

Furthermore, an epoxy-based compound represented by the following S-35 to S-37 can be also used as a surface treatment agent.

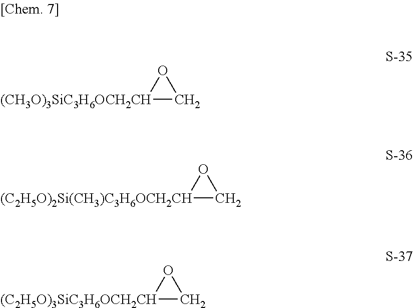

As a surface treatment method, a method of using a wet type medium dispersion device which uses 0.1 to 200 parts by weight of a surface treatment agent and 50 to 5000 parts by weight of a solvent relative to 100 parts by weight of non-treated metal oxide microparticles can be mentioned, for example.

Furthermore, according to wet type dispersion of slurry (suspension of solid particles) containing the non-treated metal oxide microparticles and surface treatment agent, pulverization of aggregates of the non-treated metal oxide microparticles and surface treatment of the non-treated metal oxide microparticles can be performed simultaneously. After that, by producing powder according to removal of a solvent, more uniform and fine metal oxide microparticles of which surface is treated with a surface treatment agent can be also obtained.

The surface treatment amount by a surface treatment agent (coating amount of a surface treatment agent) is preferably 0.1% by weight or more and 60% by weight or less relative to the metal oxide microparticles. Particularly preferably, it is 5% by weight or more and 40% by weight or less.

The surface treatment amount by a surface treatment agent is obtained as follows: a heat treatment of surface-treated metal oxide microparticles is carried out for 3 hours at 550° C., the strong heat residuals are analyzed quantitatively by fluorescent X ray, and the value is obtained from Si amount as converted in molecular weight.

The wet type medium dispersion device indicates an apparatus with filling beads as a medium in a vessel and involving steps of pulverizing and dispersing aggregated particles of metal oxide microparticles by high speed rotation of a stirring disc which is mounted at right angle to a rotation axis, and the constitution is not particularly limited as long as the non-treated metal oxide microparticles are sufficiently dispersed and surface-treated during performing a surface treatment of the non-treated metal oxide microparticles. For example, various types like a vertical type•horizontal type, a continuous type•batch type, or the like can be employed. Specific examples thereof which can be used include a sand mill, an ultravisco mill, a pearl mill, a glen mill, a dyno mill, an agitator mill, and a dynamic mill. According to these dispersion devices, pulverization and dispersion are performed based on impact compression, friction, shearing, shearing stress or the like with use of a pulverization medium like balls and beads. As for the beads that are used for a dispersion device, balls having, as a raw material, glass, alumina, zircon, zirconia, steel, flint stone, or the like can be used. In particular, those made of zirconia or zircon are preferable. Furthermore, as for the beads size, those having a diameter of 1 mm to 2 mm or so are generally used. However, in the present invention, those having a diameter of 0.3 mm to 1.0 mm or so are preferably used.

For a disc or an inner wall of a vessel used for the wet type medium dispersion device, those made of various materials like stainless, nylon, and ceramics can be used. However, in the present invention, a disc or an inner wall of a vessel is preferably made of ceramics like zirconia or silicone carbide.

According to the wet type treatment described above, metal oxide microparticles of which surfaces thereof are treated with a surface treatment agent can be obtained.

The metal oxide microparticles are contained, relative to 100 parts by volume of the polymerizable component, at a ratio of preferably 0.5 to 45 parts by volume, more preferably 1 to 40 parts by weight, and even more preferably 5 to 30 parts by volume.

Herein, specific gravity of each component for constituting the surface layer in a transfer member of the first embodiment can be calculated as 1.1 for organic matters. Specifically, it is 1.18 for DPHA, 1.11 for TMPTA, 1.165 for PETA, 1.1 for polyurethane acrylate, 1.1 for the polymerizable compound having a low surface energy group, and as metal oxide microparticles, 3.5 for alumina, 6.3 for tin oxide, 3.7 for titania, and 2.2 for silica.

[Other Additives]

In the surface layer 4, an additive component like an organic solvent, a photostabilizer, an ultraviolet absorbing agent, a catalyst, a colorant, an antistatic agent, a lubricant, a leveling agent, an anti-foaming agent, a polymerization promoter, an antioxidant, a flame retardant, an infrared absorbing agent, a surface active agent, and a surface modifying agent can be included, if necessary.

The organic solvent is used from the viewpoint of having uniform solubility and dispersion stability of a coating liquid for forming a surface layer, and also adhesiveness to a base with an endless belt shape, and smoothness and uniformity of a coating film. The organic solvent is not particularly limited, and those satisfying the above performances are sufficient. Specific examples thereof include an organic solvent like alcohol based, hydrocarbon based, halogenated hydrocarbon based, ether based, ketone based, ester based, and polyalcohol derivatives.

The layer thickness of the surface layer 4 is preferably 1 to 5 μm considering mechanical strength, image quality, production cost, or the like.

According to the transfer member described above, as the surface layer 4 includes a cured (meth)acrylic resin which is obtained by curing based on polymerization reaction using a specific photopolymerization initiator, high durability is obtained.

That is because, by using a specific photopolymerization initiator including an acylphosphine oxide compound represented by the above General Formula (1) as a photopolymerization initiator, the obtained cured (meth)acrylic resin is hardly deteriorated due to discharge during image forming process or a discharge product resulting from the discharge. Although the detailed mechanism remains unclear, it is assumed that the open chemical structure of a specific photopolymerization initiator which binds to a terminal of a cured (meth)acrylic resin is hardly deteriorated by discharge or ozone, and an unreacted acryloyl group that is easily deteriorated is reduced in the obtained cured (meth)acrylic resin.

[Method for Producing Transfer Member]

According to the method for producing a transfer member of the first embodiment, a composition containing a polymerizable component like polyfunctional (meth)acrylate, a polymerizable compound having a low surface energy group, and a polyurethane acrylate for forming a surface layer on a base and a specific photopolymerization initiator (hereinbelow, also referred to as “coating liquid for forming a surface layer”) is coated to form a coating film, which is then cured by irradiation with light to form a surface layer, and thus a transfer member can be produced.

In the case of forming a surface layer on a base intermediated by an elastic body layer, a coating liquid for forming an elastic body layer, which is used for forming an elastic body layer, is coated on a base to form a coating film, which is then dried to form an elastic body layer, and a surface layer is formed as described above on the elastic body layer.

As for the method for producing a base, when a polyimide resin is used as a constitutional material, a suitable method of a related art which includes performing development in ring shape by a suitable process like a process of immersing and coating a polyamidic acid solution on an outer peripheral surface of a tubular mold, a process of coating the solution on an inner peripheral surface, a process of performing centrifuge of the solution, or a process of filling the solution in a mold frame, molding the developed layer into belt shape by drying and film forming, and recovering the molded product after conversion of polyamidic acid into imide by a heating treatment can be performed (JP-A S61-95361, JP-A S64-22514, and JP-A H03-180309). For producing a base of an endless belt shape, a suitable treatment like mold releasing treatment or anti-foaming treatment can be performed.

As a method for preparing a coating liquid for forming an elastic body layer, a method of adding constitutional materials for forming an elastic body layer to a solvent at solid matter concentration ratio of 20 to 30% by weight can be mentioned.

Examples of the method for coating a coating liquid for forming an elastic body layer include spiral coating using nozzle.

The coating liquid for forming a surface layer contains at least polyfunctional (meth)acrylate and the specific photopolymerization initiator, and if necessary, it may further contain a polymerizable compound having a low surface energy group, polyurethane acrylate, or surface-treated metal oxide microparticles, and also other components like a solvent may be contained.

The method for preparing the coating liquid for forming a surface layer includes a method in which a solvent is added with a polymerizable component, and when surface-treated metal oxide microparticles are further contained, the metal oxide microparticles are added at solid matter concentration of 3 to 10% by weight, and dispersion is performed by a wet type medium dispersion device. As for the wet type medium dispersion device, various types like a vertical type•horizontal type, a continuous type•batch type, or the like can be employed. Specific examples thereof which can be used include a sand mill, an ultravisco mill, a pearl mill, a glen mill, a dyno mill, an agitator mill, and a dynamic mill. According to these dispersion device, pulverization and dispersion are performed based on impact compression, friction, shearing, shearing stress or the like by using a pulverization medium like balls and beads.

As for the beads that are used for a dispersion device, balls having, as a raw material, glass, alumina, zircon, zirconia, steel, flint stone, or the like can be used. In particular, those made of zirconia or zircon are preferable. Furthermore, as for the beads size, those having a diameter of 1 mm to 2 mm or so are generally used. However, in the present invention, those having a diameter of 0.3 mm to 1.0 mm or so are preferably used.

For a disc or an inner wall of a vessel used for the wet type medium dispersion device, those made of various materials like stainless, nylon, and ceramics can be used. However, in the present invention, a disc or an inner wall of a vessel is preferably made of ceramics like zirconia or silicone carbide.

The end point of the dispersion preferably corresponds to a dispersion state in which, after natural drying of a dispersion liquid coated on a PET film by a wire bar, the change rate of light transmittance at 405 nm of the film obtained by coating and drying the dispersion liquid is 3% or less compared to the light transmittance of 1 hour ago. More preferably, it is 1% or less.

According to this dispersion treatment, a coating liquid for forming a surface layer can be obtained.

From the viewpoint of having a favorable coating property (workability), the coating liquid for forming a surface layer preferably contains a solvent.

Specific examples of the solvent include ethanol, isopropanol, butanol, toluene, xylene, acetone, methyl ethyl ketone, ethyl acetate, butyl acetate, ethylene glycol diethyl ether, and propylene glycol monomethyl ether acetate.

To the coating liquid for forming a surface layer, other component like photosensitizer may be added if required.

Viscosity of the coating liquid for forming a surface layer is preferably 10 to 100 cP.

Solid matter concentration of the coating liquid for forming a surface layer is preferably 5 to 40% by weight. Meanwhile, in the coating liquid for forming a surface layer, the solid matter encompasses metal oxide microparticles, polyfunctional (meth)acrylate, polyurethane acrylate, and a polymerizable compound having a low surface energy group.

Examples of a method for coating a coating liquid for forming a surface layer include an immersion coating method and a spray coating method.

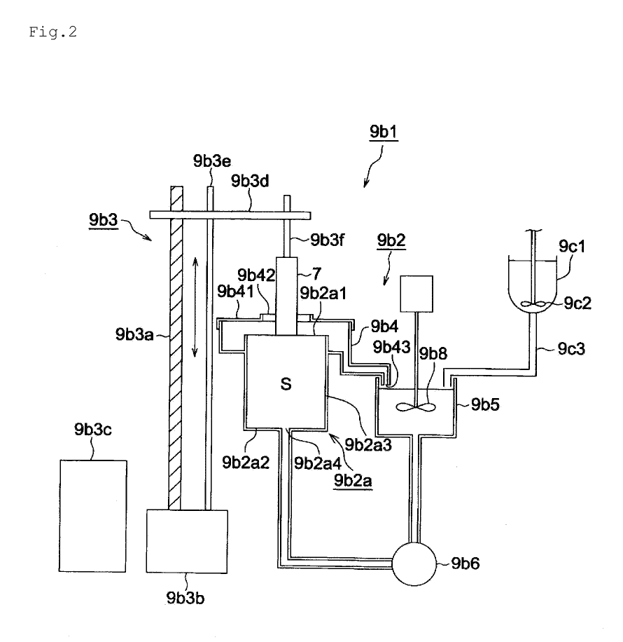

As a device for coating a coating liquid for forming a surface layer by an immersion coating method, a coating device illustrated in FIG. 2 can be mentioned.

An immersion coating device 9b1 has a coating part 9b2 and a treatment subject supply part 9b3. The coating part 9b2 has a coating bath 9b2a, an overflow receiving bath 9b4 which is disposed on top of the coating bath 9b2a for receiving the coating liquid for forming a surface layer which overflows from an opening part 9b2al of the coating bath 9b2a, a coating liquid supply tank 9b5, and a liquid transport pump 9b6.

S represents a coating liquid for forming a surface layer. Furthermore, 9c1 represents a vessel for preparing a coating liquid for forming a surface layer, 9c2 represents a stirrer, and 9c3 represents a liquid transport pipe.

The coating bath 9b2a has a bottom part 9b2a2 and a side wall 9b2a3 which is extended upward from the peripheral surface of the bottom part 9b2a2, and it has the opening part 9b2al on the top. The coating bath 9b2a has a tubular shape. The opening part 9b2al and the bottom part 9b2a2 have the same diameter. 9b2a4 indicates a supply inlet for the coating liquid which is equipped at the bottom part 9b2a2 of the coating bath 9b2a. The coating liquid for forming a surface layer S is transported from the liquid transport pump 9b6 to the coating bath 9b2a via the coating liquid supply inlet 9b2a4.

9b41 represents a cover of the overflow receiving bath 9b4, and the cover 9b41 has a hole 9b42 at the center. 9b43 represents a coating liquid returning inlet for returning the coating liquid for forming a surface layer S in the overflow receiving bath 9b4 to the coating liquid supply tank 9b5. 9b8 represents a stirring blade installed at the coating liquid supply tank 9b5.

The supply part 9b3 has a ball screw 9b3a, an operation part 9b3b for rotating the ball screw 9b3a, a control part 9b3c for controlling rotation speed of the ball screw 9b3a, an elevation member 9b3d which is screw-bonded to the ball screw 9b3a, and a guide member 9b3e which movies the elevation member 9b3d in up and down direction (arrow direction in the drawing) accompanying rotation of the ball screw 9b3a. 9b3f represents a member for holding the treatment subject 7 mounted on the elevation member 9b3d. The holding member 9b3f is mounted on the elevation member 9b3d such that the treatment subject 7 on hold can be present approximately at the center of the coating bath 9b2a.

The treatment subject 7 is hold by the holding member 9b3f which is mounted on the elevation member 9b3d. Accompanying the rotation of the ball screw 9b3a of an intermediate belt, the elevation member 9b3d moves in up and down direction. Accordingly, the treatment subject 7 holded by the holding member 9b3f is immersed in a coating liquid for forming a surface layer S in the coating bath 9b2a, and then pulled up. As a result, the surface of the treatment subject 7 is coated with the coating liquid for forming a surface layer S to form a coating film.

The speed for pulling up the treatment subject 7 needs to be suitably modified in accordance with the viscosity of a coating liquid for forming a surface layer S to be used. For example, when the coating liquid for forming a surface layer S has viscosity of 10 to 200 mPa·s, the speed for pulling up the treatment subject 7 is preferably 0.5 to 15 mm/sec in consideration of coating uniformity, coating film thickness, drying, or the like.

The polymerizable component is cured by irradiation of light.

As for the light, from the viewpoint of easy handling and easy obtainment of high energy, ultraviolet ray is preferably used. As for the light source of ultraviolet ray, anything can be used as long as it is a light source emitting ultraviolet ray. Examples thereof which can be used include a low pressure mercury lamp, a medium pressure mercury lamp, a high pressure mercury lamp, an ultra-high pressure mercury lamp, a carbon arc lamp, a metal halide lamp, and a xenon lamp. Furthermore, ArF excimer laser, KrF excimer laser, an excimer lamp, or a synchrotron radiation light can be also used. In order to have irradiation of spot-shaped ultraviolet ray, it is also preferable to use ultraviolet laser.

Conditions for light irradiation vary depending on each light source. Irradiation light amount is preferably 500 mJ/cm² or more, preferably 0.5 to 5 J/cm² or more, and particularly preferably 1 to 3 J/cm² or more considering curing unevenness, hardness, curing time, curing speed, or the like.

The irradiation light amount indicates a value measured by UIT250 (manufactured by USHIO INC.).

The light irradiation time is preferably 10 seconds to 8 minutes. From the viewpoint of curing efficiency and working efficiency, it is more preferably 30 seconds to 5 minutes.

With regard to the atmosphere during light irradiation, curing can be achieved without any problem in air atmosphere. However, considering the curing unevenness and curing time, oxygen concentration in atmosphere is preferably 1% or less, and particularly 500 ppm or less. To have such atmosphere, it is effective to introduce nitrogen gas or the like.

The oxygen concentration indicates a value which is measured by oxygen concentration meter “OX100” (manufactured by Yokogawa Electric Corporation) used for managing atmospheric gas.

After a coating liquid for forming a surface layer is coated on a base, or on an elastic body layer for a case in which an elastic body layer is formed, drying is preferably performed. Accordingly, the solvent is removed.

Drying of a coating film can be performed at any time like before, after, or during the polymerization of a polymerizable component. They may be suitably combined and selected. Specifically, it is preferable that, after performing a first drying until there is no fluidity of a coating film, polymerization of a polymerizable component be performed, and then a second drying be performed to have a defined amount of volatile materials in a surface layer.

The method for drying a coating film can be suitably selected depending on type of a solvent, the layer thickness of a surface layer to be formed, or the like. The drying temperature is preferably 60 to 120° C., and more preferably 60 to 100° C. The drying time is preferably 1 to 10 minutes, and more preferably 5 minutes or so.

[Image Forming Apparatus]

The transfer member described above can be used preferably as an intermediate transfer belt of various known image forming apparatuses of an electrophotographic type like a monochromatic image forming apparatus and a full color image forming apparatus.

In other words, according to the present invention, an image forming apparatus of an electrophotographic type having a first transfer means for first transfer of a toner image that is formed electrostatically on an image carrier to a circularly moving intermediate transfer belt and a second transfer means for second transfer of an intermediate toner image that is formed on the intermediate transfer belt to the image support, in which the intermediate transfer belt includes the aforementioned transfer member, is provided.

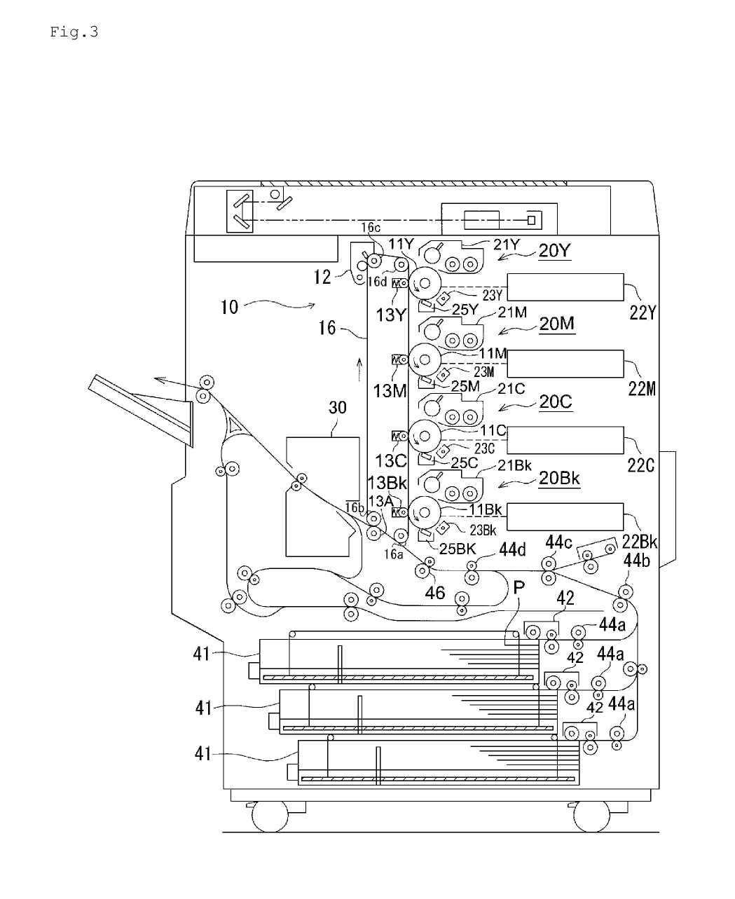

FIG. 3 is an explanatory cross-sectional view illustrating one example of a constitution of an image forming apparatus which has a transfer member of the first embodiment.

This image forming apparatus has a plural set of the image forming units 20Y, 20M, 20C, 20Bk, the intermediate transfer part 10 for transferring a toner image formed by the image forming units 20Y, 20M, 20C, 20Bk onto the recording medium P, and a fixing device 30 for performing a fixing treatment to yield a toner layer by heating and compressing against the recording medium P and fixing the toner image.

By the image forming unit 20Y, yellow-color toner image forming is performed. By the image forming unit 20M, magenta-color toner image forming is performed. By the image forming unit 20C, cyan-color toner image forming is performed. Further, by the image forming unit 20Bk, black-color toner image forming is performed.

The image forming units 20Y, 20M, 20C, 20Bk are equipped with photosensitive bodies 11Y, 11M, 11C, 11Bk, which are an electrostatic latent image carrier, charging means 23Y, 23M, 23C, 23Bk for evenly applying electric potential onto a surface of the photosensitive bodies 11Y, 11M, 11C, 11Bk, the light exposure means 22Y, 22M, 22C, 22Bk for forming an electrostatic latent image of desired shape on top of the evenly charged photosensitive bodies 11Y, 11M, 11C, 11Bk, developing means 21Y, 21M, 21C, 21Bk for developing the electrostatic latent images by conveying a color toner to the photosensitive bodies 11Y, 11M, 11C, 11Bk, and cleaning means 25Y, 25M, 25C, 25Bk for recovering residual toner which remains on top of the photosensitive bodies 11Y, 11M, 11C, 11Bk after first transfer.

The intermediate transfer part 10 has an intermediate transfer belt 16 which moves circularly, first transfer rollers 13Y, 13M, 13C, 13Bk as a first transfer means for transferring a toner image formed by the image forming units 20Y, 20M, 20C, 20Bk to the intermediate transfer belt 16, a second transfer roller 13A as a second transfer means for transferring a color toner image, which has been transferred onto the intermediate transfer belt 16 by the first transfer rollers 13Y, 13M, 13C, 13Bk, onto the recording medium P, and a cleaning means 12 for recovering remaining toner which remains on top of the intermediate transfer belt 16.

As the intermediate transfer belt 16, a transfer member of the first embodiment is used.

The intermediate transfer belt 16 is extended by plural supporting rollers 16a to 16d and it has an endless belt shape supported in a circulating state.

In addition, the intermediate transfer belt 16 has a structure in which a specific surface layer containing a cured (meth)acrylic resin and metal oxide microparticles is formed on an outer peripheral surface of the base, or on an outer peripheral surface of the elastic body layer when the elastic body layer is formed.

The toner image with respective color which is formed by the image forming units 20Y, 20M, 20C, 20Bk is transferred in a stepwise manner by the first transfer roller 13Y, 13M, 13C, 13Bk onto the endless intermediate transfer belt 16 which moves circularly, and thus an overlapped color image is formed. The recording medium P stored in a feeding cassette 41 is fed by a feed conveying means 42, and via plural intermediate roller 44a to 44d and a resist roller 46, it is conveyed to the second transfer roller 13A as a second transfer means, and as a result, the color image is collectively transferred onto the recording medium P.

The recording medium P with transferred color image is subjected to a fixing treatment by the fixing device 30 which is equipped with a heat roller fixing device, and after being taken by the ejection roller, it is placed on an ejection tray outside the apparatus.

Meanwhile, after the transfer of a color image onto the recording medium P by the second transfer roller 13A, the endless intermediate transfer belt 16 having the recording medium P separated according to curvature is subjected to removal of remaining toner by the cleaning means 12.

According to the image forming apparatus described above, the intermediate transfer belt includes a transfer member of the first embodiment so that the intermediate transfer belt can have high durability. As a result, an image with high image quality can be formed for a long period of time.

[Developing Agent]

The developing agent which is used for an image forming apparatus of the second embodiment can be a one-component developing agent with magnetic or non-magnetic toner, or a two-component developing agent in which a toner and a carrier are mixed with each other.

The toner for constituting the developing agent is not particularly limited, and various known ones can be used. However, it is preferable to use a so-called polymerization toner which is obtained by polymerization method and has a volume-based median diameter of 3 to 9 μm. By using the polymerization toner, high resolution power in an image to be formed and stable image concentration are obtained and also an occurrence of an image fogging is significantly suppressed.

The carrier for constituting a two-component developing agent is not particularly limited, and various known ones can be used. However, it is preferably ferrite carrier including magnetic particles which has a volume-based median diameter of 30 to 65 μm and magnetization amount of 20 to 70 emu/g. When a carrier with a volume-based median diameter of less than 30 μm is used, carrier adhesion occurs so that a whitening phenomenon may occur. On the other hand, when a carrier with a volume-based median diameter of more than 65 μm is used, there can be a case in which an image with uniform image concentration is not formed.

[Recording Medium (Image Support)]

Examples of the recording medium P which is used for an image forming apparatus of the second embodiment include thin paper as well as thick paper like regular paper, high quality paper, printed coating paper like art paper or coating paper, commercially available Japanese paper or post card paper, a plastic film for OHP, and fabrics, but not limited to them.

Hereinabove, embodiments of the present invention are described specifically. However, embodiments of the present invention are not limited to the above examples, and various modifications can be made therefor.

### EXAMPLES

Hereinbelow, specific examples of the present invention are described, but the present invention is not limited to them.

### Example 1

### Example 1 for Producing Transfer Member

(1) Production of Base with Endless Belt Shape

To “U-Varnish S (solid matter content: 18% by weight)” (manufactured by UBE INDUSTRIES, LTD.), which is N-methyl-2-pyrrolidone (NMP) solution of polyamidic acid including 3,3′,4,4′-biphenyltetracarboxylic acid dianhydride (BPDA) and p-phenylenediamine (PDA), dried and oxidized carbon black “SPECIAL BLACK4” (manufactured by Degussa, pH 3.0, volatile component: 14.0%) was added such that it is 23 parts by weight relative to 100 parts by weight of the solid matter of a polyimide resin. By using a collision type disperser “GeanusPY” (manufactured by GEA-NUS PPRL), collision was performed at a pressure of 200 MPa with minimum area of 1.4 mm² after dividing it into two parts, and followed by passing through the path dividing into two parts for five times, and then followed by mixing, a polyamidic acid solution containing carbon black was obtained.

The polyamidic acid solution containing carbon black was coated to 0.5 mm on an inner peripheral surface of a tubular mold by using a dispenser with rotation at 1500 rpm for 15 minutes, and then, a development layer with even thickness was prepared. Then, after applying hot air at 60° C. from the outside of the mold for 30 minutes while having rotation at 250 rpm, it was heated at 150° C. for 60 minutes. After that, the temperature was increased to 360° C. with a temperature increase rate of 2° C./minute, and according to further heating at 360° C. for 30 minutes, the solvent was removed, dehydrated water of ring closure was removed, and the imide conversion reaction was completed. Then, the temperature was brought back to room temperature and, according to peeling from the tubular mold, the base [1] with endless belt shape having a thickness of 0.1 mm was produced.

(2) Forming of Surface Layer

(2-1) Synthesis of Polymerizable Compound Having Low Surface Energy Group

(a) Synthesis of IPDI Adduct

222 parts by weight of isophorone diisocyanate (IPDI) were heated to 80° C. in a 1 liter four neck flask under air. Then, 116 parts by weight of 2-hydroxyethylacrylate and 0.13 part by weight of hydroquinone were added dropwise thereto over 2 hours. The reaction was allowed to occur additionally at 80° C. for 3 hours to obtain a compound [X] which has one isocyanate group and one vinyl group (IPDI adduct).

(b) Synthesis of the Polymer [1]

15 parts by weight of a polysiloxane compound containing methacryloxy group at one end (“Silaplane FM-0721” manufactured by JNC), 70 parts by weight of 2-hydroxyethyl methacrylate, 15 parts by weight of butyl methacrylate, and 200 parts by weight of methyl isobutyl ketone (MIBK) were added to a four neck flask equipped with a condenser tube, a stirrer, and a thermometer, and the temperature was increased to 80° C. with stirring under nitrogen stream. After adding 3 parts by weight of azobis isobutyronitrile thereto, the polymerization reaction was allowed to occur for 2 hours. After further adding 1 part by weight of azobis isobutyronitrile thereto, the polymerization reaction was allowed to occur for 2 hours. Subsequently, a solution containing 204 parts by weight of the compound [X] (IPDI adduct) and 1 part by weight of tin octylate dissolved in 20 parts by weight of methyl ethyl ketone (MEK) was added dropwise thereto over 10 minutes approximately, and the reaction was allowed to occur for 2 hours after the dropwise addition. To the obtained solution, cyclohexanone was added to have 10% by weight of non-volatiles. As a result, a solution of the polymer [1] was obtained. The weight average molecular weight of the polymer [1] was about 20,000.

(2-2) Production of Surface-Treated Metal Oxide Microparticles

100 parts by volume of alumina microparticles with the number average primary particle diameter of 34 nm were mixed with 15 parts by volume of the surface treatment agent [1](silicone oil having one end modified with carbinol (manufactured by Shin-Etsu Chemical Co., Ltd., “X-22-170DX”)) and 400 parts by volume of a solvent (mixture solvent of toluene:isopropyl alcohol=1:1 (volume ratio)). By using a wet type medium dispersion device, dispersion was performed and the solvent was removed. By drying at 150° C. for 30 minutes, a surface-treated metal oxide microparticles [P1] were obtained.

(2-3) Production of Coating Liquid for Forming Surface Layer
polyfunctional (meth)acrylate: dipentaerythritol hexaacrylate (DPHA), 75 parts by volume
polymerizable compound having a low surface energy group: the polymer [1], 15 parts by volume
metal oxide microparticles [P1], 10 parts by volume
photopolymerization initiator: compound represented by the above Formula (1-2), 5 parts by volume

The above were dissolved and dispersed in a solvent of propylene glycol monomethyl ether acetate (PMA) to have solid matter concentration of 10% by weight, and thus the coating liquid [1] for forming a surface layer was prepared.

(2-4) Forming of Surface Layer

The coating liquid [1] for forming a surface layer was coated on an outer peripheral surface of the base [1] with endless belt shape according to an immersion coating method under following coating conditions by using a coating device illustrated in FIG. 2 to form a coating film with a dry film thickness of 5 μm. Then, according to irradiation of ultraviolet ray under the following irradiation conditions, the coating film was cured to form a surface layer. Accordingly, the transfer member [1] was obtained. The ultraviolet ray irradiation was performed by rotating at the circumference speed of 60 mm/sec the substrate having a coating film formed on an outer peripheral surface of the base [1] with endless belt shape while the light source is fixed.

—Conditions for Coating—

Coating liquid supply amount: 1 L/min

—Conditions for Ultraviolet Ray Irradiation—

Type of light source: High pressure mercury lamp “H04-L41” (manufactured by EYE GRAPHICS CO., LTD.)

Distance from irradiation port to surface of coating film: 100 mm

Light amount for irradiation: 1 J/cm²

Irradiation time (time for substrate rotation): for 240 seconds

### Examples 2 to 8

### Examples 2 to 8 for Producing Transfer Member

The transfer member [2] to [8] were prepared in the same manner as the Example 1 for producing transfer member except that, regarding the step for producing (2-3) Coating liquid for forming a surface layer, coating liquids for forming a surface layer are prepared according to the formulation of Table 1 and each of them is used for a step for forming a surface layer.

Meanwhile, in Table 1, “TMPTA” represents trimethylol propane triacrylate, “PETA” represents pentaerythritol tetraacrylate, “Formula (1-1)” represents a compound which is expressed by the above Formula (1-1), “Formula (1-7)” represents a compound which is expressed by the above Formula (1-7), and “Formula (1-5)” represents a compound which is expressed by the above Formula (1-5).

Furthermore, with regard to the number average primary particle diameter of the microparticles that are used as metal oxide described in Table 1, it was 25 nm for silica microparticles and 20 nm for tin oxide microparticles.

TABLE 1

| | | | Surface layer | | | | | | | | | |
|---|---|---|---|---|---|---|---|---|---|---|---|---|
| | | | Formulation of photocurable composition | | | | | | | | | |
| | | | | | Polymer with low | | | | | | | |
| | | | Polyfunctional | | surface energy | | | | | | | |
| | | | (meth)acrylate | | group | | Urethane acrylate | | Metal oxide microparticles | | | |
| | | | | Addition | | Addition | | Addition | | | Addition | |
| | | | | amount | | amount | | amount | | | amount | |
| | Transfer | | | (parts | | (parts | | (parts | | Surface | (parts | Photo- |
| | member | Elastic | | by | | by | | by | | treatment | by | polymerization |
| | No. | layer | Type | volume) | Type | volume) | Type | volume) | Type | agent | volume) | initiator |
| Example 1 | [1] | — | DPHA | 75 | Polymer | 15 | — | | Alumina | [1] | 10 | Formula (1-2) |
| | | | | | [1] | | | | | | | |
| Example 2 | [2] | — | DPHA | 75 | Polymer | 15 | — | | Alumina | [1] | 10 | Formula (1-1) |
| | | | | | [1] | | | | | | | |
| Example 3 | [3] | — | DPHA | 75 | Polymer | 15 | — | | Silica | [1] | 20 | Formula (1-2) |
| | | | | | [1] | | | | | | | |
| Example 4 | [4] | — | TMPTA | 65 | Polymer | 20 | — | | Alumina | [1] | 15 | Formula (1-2) |
| | | | | | [1] | | | | | | | |
| Example 5 | [5] | — | PETA | 80 | Polymer | 10 | — | | Tin | [1] | 10 | Formula (1-1) |
| | | | | | [1] | | | | oxide | | | |
| Example 6 | [6] | — | DPHA | 75 | Polymer | 15 | — | | Alumina | [1] | 10 | Formula (1-7) |
| | | | | | [1] | | | | | | | |
| Example 7 | [7] | — | DPHA | 75 | Polymer | 15 | — | | Silica | [1] | 20 | Formula (1-7) |
| | | | | | [1] | | | | | | | |
| Example 8 | [8] | — | DPHA | 75 | Polymer | 15 | — | | Alumina | [1] | 10 | Formula (1-5) |
| | | | | | [1] | | | | | | | |
| Example 9 | [9] | Present | DPHA | 25 | Polymer | 20 | UV03000B | 50 | Alumina | [1] | 5 | Formula (1-2) |
| | | | | | [2] | | | | | | | |
| Example 10 | [10] | Present | TMPTA | 25 | Polymer | 15 | UX-3204 | 50 | Tin | [2] | 10 | Formula (1-2) |
| | | | | | [3] | | | | oxide | | | |
| Comparative | [11] | — | DPHA | 75 | Polymer | 15 | — | | Alumina | [1] | 10 | 379 |
| Example 1 | | | | | [1] | | | | | | | |
| Comparative | [12] | Present | DPHA | 25 | Polymer | 20 | UV-3000B | 50 | Alumina | [1] | 5 | 127 |
| Example 2 | | | | | [2] | | | | | | | |

### Example 9

### Example 9 for Producing Transfer Member

(1) Production of Base with Endless Belt Shape

The base [1] with endless belt shape was produced in the same manner as the (1) Production of base with endless belt shape of the Example 1 for producing transfer member which has been described above.

(2) Forming of Elastic Body Layer

By adding 30 parts by weight of furnace black (manufactured by ASAHI CARBON CO., LTD.) to 100 parts by weight of chloroprene rubber (manufactured by DENKI KAGAKU KABUSHIKIKAISHA) followed by kneading, an elastic body material was obtained. The resulting elastic body material was dissolved and dispersed in a solvent (toluene) to have solid matter concentration of 20% by weight. Accordingly, the coating liquid [1] for forming an elastic layer was prepared.

On top of the base [1] with endless belt shape, the coating liquid [1] for forming an elastic layer was coated by spiral coating using a nozzle, and thus the elastic body layer [1] with a dry film thickness of 200 μm was formed.

(3) Forming of Surface Layer

(3-1) Synthesis of Polymerizable Compound Having Low Surface Energy Group

20 parts by weight of a polysiloxane compound containing methacryloxy group at one end (“Silaplane FM-0721” manufactured by JNC), 70 parts by weight of glycidyl methacrylate, 10 parts by weight of butyl methacrylate, and 200 parts by weight of methyl isobutyl ketone (MIBK) were added to a four neck flask equipped with a condenser tube, a stirrer, and a thermometer, and the temperature was increased to 90° C. with stirring under nitrogen stream. After adding 3 parts by weight of azobis isobutyronitrile thereto, the polymerization reaction was allowed to occur for 2 hours. After further adding 1 part by weight of azobis isobutyronitrile thereto, the polymerization reaction was allowed to occur for 2 hours. Subsequently, the temperature was increased to 100° C., injection gas was changed from nitrogen to air, and 0.7 part by weight of dimethyl benzylamine was added. After that, 35 parts by weight of acrylic acid was added dropwise thereto for about 10 minutes. After the dropwise addition, the reaction was allowed to occur for 10 hours. To the obtained solution, cyclohexanone was added to have 10% by weight of non-volatiles. As a result, a solution of the polymer [2] was obtained. The weight average molecular weight of the polymer [2] was about 17,000.

(3-2) Production of Surface-Treated Metal Oxide Microparticles

The surface-treated metal oxide microparticles [P1] was produced in the same manner as the process for (2-2) Production of surface-treated metal oxide microparticles of the Example 1 for producing transfer member which has been described above.

(3-3) Production of Coating Liquid for Forming Surface Layer
polyurethane acrylate: “UV-3000B” (manufactured by The Nippon Synthetic Chemical Industry Co., Ltd.), 50 parts by volume
polyfunctional (meth)acrylate: dipentaerythritol hexaacrylate (DPHA), 25 parts by volume
polymerizable compound having a low surface energy group: the polymer [2], 20 parts by volume
metal oxide microparticles [P1], 5 parts by volume
photopolymerization initiator: compound represented by the above Formula (1-2), 5 parts by volume

The above were dissolved and dispersed in a solvent of propylene glycol monomethyl ether acetate (PMA) to have solid matter concentration of 10% by weight, and thus the coating liquid [2] for forming a surface layer was prepared.

(3-4) Forming of Surface Layer

The coating liquid [2] for forming a surface layer was coated on an outer peripheral surface of the base [1] with endless belt shape according to an immersion coating method under following coating conditions by using a coating device illustrated in FIG. 2 to form a coating film with a dry film thickness of 5 μm. Then, according to irradiation of ultraviolet ray under the following irradiation conditions, the coating film was cured to form a surface layer. Accordingly, the transfer member [9] was obtained. The ultraviolet ray irradiation was performed by rotating at the circumference speed of 60 mm/sec the substrate having a coating film formed on an outer peripheral surface of the base [1] with endless belt shape while the light source is fixed.

—Conditions for Coating—

Coating liquid supply amount: 1 L/min

—Conditions for Ultraviolet Ray Irradiation—

Type of light source: High pressure mercury lamp “H04-L41” (manufactured by EYE GRAPHICS CO., LTD.) Distance from irradiation port to surface of coating film: 100 mm

Light amount for irradiation: 1 J/cm²

Irradiation time (time for substrate rotation): for 240 seconds

### Example 10

### Example 10 for Producing Transfer Member

The transfer member [10] was prepared in the same manner as the Example 5 for producing transfer member except that, regarding the step for producing (2-3) Coating liquid for forming a surface layer, coating liquids for forming a surface layer are prepared according to the formulation of Table 1 and each of them is used for a step for forming a surface layer.

Meanwhile, in Table 1, the surface treatment agent [2] is “X-22-176DX” (manufactured by Shin-Etsu Chemical Co., Ltd.), which is silicone oil having a single end modified with diol. Furthermore, the polymer [3] has been synthesized as described above.

(Synthesis of the Polymer [3])

25 parts by weight of a polysiloxane compound containing methacryloxy group at one end (“Silaplane FM-0721” manufactured by JNC), 30 parts by weight of methacryloyloxyethylisocyanate, 45 parts by weight of butyl methacrylate, and 200 parts by weight of methyl ethyl ketone (MEK) were added to a four neck flask equipped with a condenser tube, a stirrer, and a thermometer, and the temperature was increased to 80° C. with stirring under nitrogen stream. After adding 1.6 parts by weight of azobisisobutyronitrile thereto, the polymerization reaction was allowed to occur for 2 hours. After further adding 0.4 part by weight of azobis isobutyronitrile thereto, the polymerization reaction was allowed to occur for 2 hours. Subsequently, a solution containing 25.2 parts by weight of 2-hydroxyethyl methacrylate and 0.6 part by weight of tin octylate dissolved in 20 parts by weight of methyl ethyl ketone (MEK) was added dropwise thereto over 10 minutes approximately, and the reaction was allowed to occur for 2 hours after the dropwise addition. To the obtained solution, cyclohexanone was added to have 20% by weight of non-volatiles. As a result, a solution of the polymer [3] was obtained. The weight average molecular weight of the polymer [3] was about 24,000.

### Comparative Example 1

### Example 11 for Producing Transfer Member

The transfer member [11] was prepared in the same manner as the Example 1 for producing transfer member except that “Irgacure 379” (manufactured by BASF Japan Ltd.) is used as a photopolymerization initiator.

### Comparative Example 2

### Example 12 for Producing Transfer Member

The transfer member [12] was prepared in the same manner as the Example 9 for producing transfer member except that “Irgacure 127” (manufactured by BASF Japan Ltd.) is used as a photopolymerization initiator.

[Evaluation 1: Wear Amount]

As an intermediate transfer body, each of the transfer members [1] to [12] was mounted on “Bizhub PRO C6500” (manufactured by KONICA MINOLTA, INC.). After optimizing the light exposure amount, a full color image having a printing rate of 2.5% for each color of yellow (Y), magenta (M), cyan (C), and black (Bk) was printed on one million pieces of a neutral paper under the environment including temperature of 20° C. and humidity of 50% RH. The film thickness of each surface layer was measured before and after printing the million pieces, and the wear amount was measured. The results are shown in Table 2. In the present invention, a case in which the wear amount after printing million pieces is 5 m or less was found to be acceptable.

[Evaluation 2: Fine Line Reproducibility]

As an intermediate transfer body, each of the transfer members [1] to [12] was mounted on “Bizhub PRO C6500” (manufactured by KONICA MINOLTA, INC.). After optimizing the light exposure amount, a full color image having a printing rate of 2.5% for each color of yellow (Y), magenta (M), cyan (C), and black (Bk) was printed on one million pieces of a neutral paper under the environment including temperature of 20° C. and humidity of 50% RH. Before and after printing the million pieces, an image of fine lines each having a width of 30 μm was printed out, and the fine line reproducibility was evaluated in view of the width increase of the fine lines before and after printing the million pieces. The results are shown in Table 2. In the present invention, a case in which the width increase of the fine lines after printing the million pieces is less than 7% was found to be acceptable.

TABLE 2

Evaluation result

| | Wear | Thickness increase |
|---|---|---|
| | amount | amount of fine lines |
| | (μm) | (%) |
| Example 1 | 0.20 | 3.7 |
| Example 2 | 0.20 | 4.0 |
| Example 3 | 0.18 | 4.3 |
| Example 4 | 0.40 | 3.3 |
| Example 5 | 0.15 | 2.3 |
| Example 6 | 0.18 | 6.0 |
| Example 7 | 0.16 | 5.3 |
| Example 8 | 0.20 | 6.7 |
| Example 9 | 1.60 | 1.7 |
| Example 10 | 2.80 | 3.0 |
| Comparative | 2.30 | 11.3 |
| Example 1 | | |
| Comparative | 9.00 | 14.7 |
| Example 2 | | |

While preferred embodiments of the present invention have been described above, these embodiments have been presented by way of examples for explaining the present invention only, and are not intended to limit the scope of the present invention. The present invention can be performed according to various modes that are different from the above embodiments as they would fall within the scope of the present invention.

The present application is based on Japanese Patent Application No. 2014-133925 filed on Jun. 30, 2014 and its disclosure is incorporated herein by reference in their entirety.

1. A transfer member with an endless belt shape for constituting an image forming apparatus of an electrophotographic type, wherein
a surface layer is formed on a base, and
the surface layer comprises a cured (meth)acrylic resin which is obtained by curing of polyfunctional (meth)acrylate according to a polymerization reaction using a photopolymerization initiator comprising an acylphosphine oxide compound represented by the following General Formula (1): 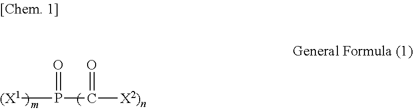
[in General Formula (1), n and m each represents an integer of 1 to 2 (with the proviso that, the relationship of m+n=3 is satisfied), and X¹ and X² each represents an alkyl group, a phenyl group which may have a substituent group, or an alkoxy group].

2. The transfer member according to claim 1, wherein
the surface layer comprises the cured (meth)acrylic resin and surface-treated metal oxide microparticles, and
the cured (meth)acrylic resin is obtained by curing of the polyfunctional (meth)acrylate and a polymerizable compound having a low surface energy group other than the polyfunctional (meth)acrylate according to a polymerization reaction which uses the photopolymerization initiator comprising the acylphosphine oxide compound represented by the General Formula (1).

3. An image forming apparatus having a first transfer means for first transfer of a toner image that is formed electrostatically on an image carrier to a circularly moving intermediate transfer belt and a second transfer means for second transfer of an intermediate toner image that is formed on the intermediate transfer belt to an image support, wherein the intermediate transfer belt is made of the transfer member according to claim 1.
